(19) United States
(12) Patent Application Publication
(10) Pub. No.: US 2008/0136073 A1
(43) Pub. Date: Jun. 12, 2008

(54) Adjustable device for damping oscillations in a steering wheel or in a gas bag module

(75) Inventor: Martin Kreuzer, Kleinwallstadt (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/982,760

(22) Filed: Nov. 5, 2007

(30) Foreign Application Priority Data
Nov. 6, 2006 (DE) 20 2006 016 948.2

(51) Int. Cl. F16F 7/00

(52) U.S. Cl. 267/140.11

(57) ABSTRACT

A device for damping oscillations in a steering wheel or in a gas bag module includes an absorption mass, a damping means (14) which is connected to the absorption mass and comprises a damping element (16), and a control means for changing the mechanical oscillating properties of the device and which is coupled to the damping means (14). The control means includes a shiftable mechanical control element (22) which cooperates with the damping element (16). The shifting of the control element (22) permits the adjustment of the intrinsic frequency of the device.

### TECHNICAL FIELD

The invention relates to a device for damping oscillations in a steering wheel or in a gas bag module.

### BACKGROUND OF THE INVENTION

Devices for damping the oscillations of the steering wheel, which are also referred to as oscillation absorbers, are known in multiple configurations. A variant often used is the rubber-elastic mounting of an absorption mass to the steering wheel hub. Oscillation absorbers are usually tuned to a certain frequency. It is thus aimed at a resonance absorption in order to reduce the oscillation amplitude of the steering wheel as far as possible.

For a given mass, the tuning of the damping means to the frequency that is to be damped is realized by selecting an appropriate rigidity of the rubber compound. That means that a new rubber compound has to be developed for each frequency. Furthermore, constructive adaptations are necessary. The oscillation frequency of the steering wheel can however vary even in the same vehicle type already because the vehicle has a different equipment. There is thus a need for an oscillation absorber structure in which the tuning to the frequency that is to be damped can be realized at a later point of time.

German Utility Model DE-U-201 04 043 discloses an adjustable device for damping oscillations, comprising an absorption mass, a damping means which is connected to the absorption mass and comprises a damping element, and a control means for changing the mechanical oscillating properties of the device and which is coupled to the damping means. The mechanical oscillating properties of this device can be changed such that different oscillation frequencies of the vehicle steering wheel which occur due to the different road influences and the changing motor oscillations at different speeds can be damped. The modification of the mechanical oscillating properties of the device is obtained by an electric control means which supplies electric energy to the damping element of the damping means. The material of the damping means is chosen such that it changes its mechanical properties when electric energy is supplied.

It is an object of the invention to provide a cost effective adjustable oscillation damping for a steering wheel.

### BRIEF SUMMARY OF THE INVENTION

According to the invention, a device for damping oscillations in a steering wheel or in a gas bag module comprises an absorption mass, a damping means which is connected to the absorption mass and comprises a damping element, and a control means for changing the mechanical oscillating properties of the device and which is coupled to the damping means. The control means comprises a shiftable mechanical control element which cooperates with the damping element. The shifting of the control element permits the adjustment of the intrinsic frequency of the device. The structure according to the invention has the advantage that the adjustment of the oscillation frequency is not realized by a complicated modification of the material properties but by a purely mechanical action on the damping means. It is therefore possible to provide a standard oscillation absorber having always the same design and the same rubber compound. In comparison with the solutions known so far, it is thus possible to use a simple assembly suitable for serial production, which leads to a considerable reduction in the costs associated to this assembly. The frequency to be damped is adjusted later when the concrete facts as to the vehicle type and the equipment are fixed.

For the modification of the oscillation frequency of the oscillation absorber, the invention preferably provides a device in which the oscillation amplitude (the free excursion) of the device can be adjusted by the control element.

According to a preferred embodiment of the invention, the damping means comprises a compression component exerting a clamping force on the damping element, the clamping force being adjustable by the control element. In this way, the rigidity of the damping means, the square of which enters in the frequency tuning, can be modified.

The compression component preferably includes a metal sheet or a plate which is directly or indirectly engaged by the shiftable control element.

Preferably, a screw or a pin which permits the shifting by a simple tool serves as the control element.

According to a further development of the invention, the control means shifts the control element automatically by an open or closed loop control, wherein the data of an oscillation sensor which is mounted to the steering column can be taken into account for the closed loop control.

### BRIEF DESCRIPTION OF THE DRAWINGS

FIG. 1 shows a sectional view of a first embodiment of the device according to the invention;

FIG. 2 shows a sectional view of a second embodiment of the device according to the invention; and

FIG. 3 shows a sectional view of a third embodiment of the device according to the invention.

### DETAILED DESCRIPTION OF THE PREFERRED EMBODIMENTS

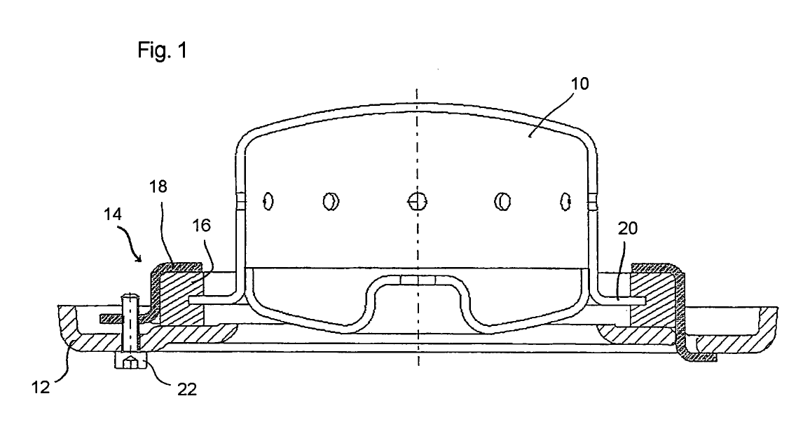

FIG. 1 shows a gas generator 10 of a driver-side gas bag module. The gas generator 10 is attached to a supporting metal sheet 12 which is configured as a gas bag supporting metal sheet and can be mounted to the steering wheel hub. The attachment of the gas generator 10 to the supporting metal sheet 12 is realized by a damping means 14 which in this case comprises an encircling damping element 16 and a compression metal sheet 18 (or a corresponding plate). The damping element 16 is made of elastomer material scorched to the supporting metal sheet 12 and is suitable for the damping of oscillations. The gas generator 10 and the damping means 14 together form a device for damping oscillations in a steering wheel or in a gas bag module, which in the following is called oscillation absorber. The gas generator 10 serves as absorption mass.

The damping element 16 engages around a flange 20 of the gas generator 10 and is itself pressed by the compression metal sheet 18 against the supporting metal sheet 12. For this purpose, at least one screw 22 is provided which projects through the supporting metal sheet 12 and which engages the compression metal sheet 18 directly or indirectly. For example, a thread can be provided directly at the edge of an opening of the compression metal sheet 18, or the screw 22 cooperates with a nut arranged on the side facing away from the supporting metal sheet 12.

The screw 22 serves as a shiftable control element by which the force exerted by the compression metal sheet 18 on the damping element 16 is adjusted. The higher this clamping force, the higher the rigidity of the damping element 16. The oscillation frequency of the oscillation absorber can thus be tuned to the oscillation frequency of the steering wheel under the given circumstances by shifting the screw 22.

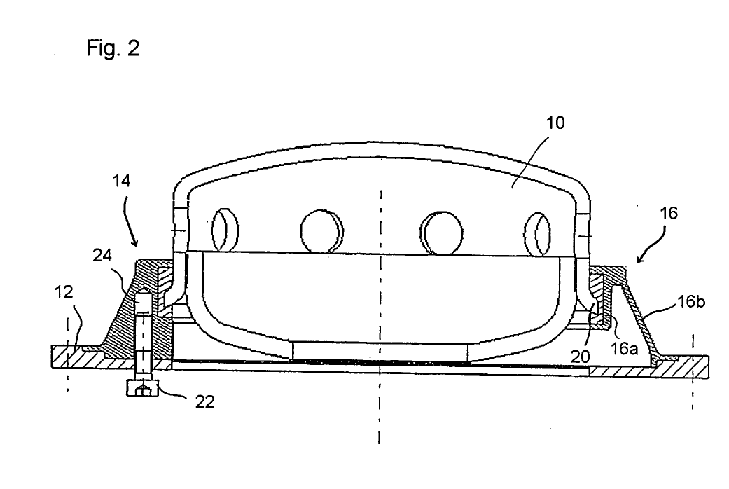

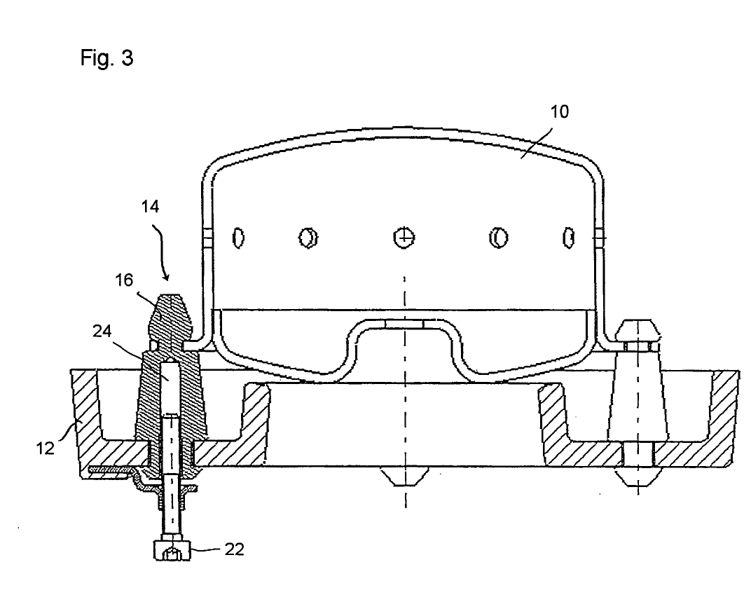

As to the embodiments according to the invention which are represented in FIGS. 2 and 3, the same reference numbers are used for the components which correspond to those of the embodiment described above or which have the same function, and only essential differences are described in detail in the following.

In the embodiment shown in FIG. 2, the gas generator 10 is suspended on the supporting metal sheet 12 by an encircling damping element 16. The damping element 16 comprises a first portion 16a which is connected to the gas generator flange 20 or to a connecting component mounted thereon, and a second portion 16b which is connected to the supporting metal sheet 12 and has the form of a truncated cone.

At least at one site, the damping element 16 has a thickened part such that no radial space is present between the two portions 16a, 16b of the damping element 16. An axial bore 24 is arranged in this thickened part of the damping element 16. The bore 24 does not pass through, but has a predetermined depth, the screw 22 penetrating into the bore 24. The maximum deflection of the damping element 16, particularly in axial direction, varies depending on how deep the screw 22 is screwed into the bore 24. Due to the adjustment of the oscillation amplitude thus permitted, the oscillating behaviour of the oscillation absorber can be tuned to the desired frequency.

In the embodiment shown in FIG. 3, the gas generator 10 is fastened to the supporting metal sheet 12 so as to be able to oscillate by a plurality of damping elements 16 which have the form of pegs and are arranged such that they are distributed in a circumferential direction. An axial bore 24 which does not pass through, but having a predetermined depth is arranged in at least one of the damping elements 16, the screw 22 penetrating into the bore 24. The maximum deflection of the damping element 16 varies depending on how deep the screw 22 is screwed into the bore 24. The effect is thus basically the same as in the embodiment shown in FIG. 2.

A further development of the invention provides an automatic control of the oscillation frequency of the oscillation absorber by an open or closed loop control, in which a control means drives an adjusting mechanism. The control means determines depending on sensor data how far the adjusting mechanism introduces the screw 22 (or a pin) into the damping element 16. The sensor data can for example include the data of an oscillation sensor arranged on the steering column which is transmitted to the control means.

Unlike the embodiments described above, the entire gas bag module or a separate mass, instead of the gas generator 10, can serve as absorption mass.

1. A device for damping oscillations in a steering wheel or in a gas bag module, the device comprising
an absorption mass,
a damping means which is connected to the absorption mass and comprises a damping element, and
a control means for changing the mechanical oscillating properties of the device and which is coupled to the damping means,
the control means comprising a shiftable mechanical control element which cooperates with the damping element, the shifting of the control element permitting the adjustment of the intrinsic frequency of the device.

2. The device according to claim 1, wherein the absorption mass is supported on the damping element so as to be able to oscillate.

3. The device according to claim 1, wherein the oscillation amplitude of the device can be adjusted by the control element.

4. The device according to claim 1, wherein the damping means comprises a compression component exerting a clamping force on the damping element, the clamping force being adjustable by the control element.

5. The device according to claim 4, wherein the compression component includes one of a metal sheet and a plate which is directly or indirectly engaged by the shiftable control element.

6. The device according to claim 1, wherein the damping element is an encircling component by which the absorption mass is suspended so as to be able to oscillate.

7. The device according to claim 6, wherein the damping element comprises a first portion coupled to the absorption mass and a second portion radially spaced apart from the first portion.

8. The device according to claim 7, wherein the damping element comprises at least at one site a thickened part having a bore into which the shiftable control element penetrates.

9. The device according to claim 1, wherein the damping means comprises a plurality of damping elements which are arranged such that they are distributed in a circumferential direction.

10. The device according to claim 9, wherein the damping elements include pegs on which the absorption mass is suspended so as to be able to oscillate.

11. The device according to claim 9, wherein at least one damping element has a bore into which the shiftable control element penetrates.

12. The device according to claim 8, wherein the bore extends axially.

13. The device according to claim 1, wherein the control element includes one of a screw and a pin.

14. The device according to claim 1, wherein the control element at the same time is a fastening element of the damping means.

15. The device according to claim 1, wherein the control means shifts the control element automatically by open or closed loop control.
